(19) United States
(12) Patent Application Publication
(10) Pub. No.: US 2024/0378230 A1
(43) Pub. Date: Nov. 14, 2024

(54) METHODS AND SYSTEMS FOR VISUAL CONTENT RETRIEVAL USING SEMANTIC SEARCH

(71) Applicant: CIPIO INC, McLean, VA (US)

(72) Inventors: Jin YU, Union CITY, CA (US); Sundeep SANGHAVI, Wesley Chapel, FL (US); Xunhui YU, North Wales, PA (US)

(73) Assignee: CIPIO, INC, McLean, VA (US)

(21) Appl. No.: 18/661,459

(22) Filed: May 10, 2024

Related U.S. Application Data
(60) Provisional application No. 63/501,730, filed on May 12, 2023.

(51) Int. Cl. G06F 16/383; G06F 16/33

(52) U.S. Cl. CPC G06F 16/383; G06F 16/3347

(57) ABSTRACT

This application directs to methods and systems for visual content retrieval using semantic search. An embodiment provides a method for generating media feature vectors from media data segments using jointly trained machine learning models, and storing these with entity indicators in a vector-based search database. An input vector is generated from text or image data, and a processor calculates cosine similarities between the input vector and existing media feature vectors to retrieve and rank relevant media segments. The method also includes generating a mean feature vector from the retrieved set and comparing it with mean feature vectors of other entities for ranking. There are other embodiments as well.

### CROSS-REFERENCES TO RELATED APPLICATIONS

This application claims priority to U.S. Provisional Patent Applicant No. 63/501,730, filed May 12, 2023, which is commonly owned and incorporated by reference herein for all purposes.

### BACKGROUND OF THE INVENTION

In the field of information retrieval, there has been a large body of research focusing on keyword-based search of textual content (e.g., search engines such as Google and Microsoft Bing). There are also numerous works in keyword-based image searches; and the primary method here is to tag the images with keywords first and index them for later keyword-based retrieval.

Unfortunately, existing approaches have been inadequate, for reasons explained below. New and improved methods and systems are desired.

### BRIEF DESCRIPTION OF THE DRAWINGS

FIG. 1 is a simplified flow diagram illustrating an image encoding process according to embodiments of the present invention.

FIG. 2 is a simplified flow diagram illustrating an image encoding process with entity embeddings according to embodiments of the present invention.

FIG. 3 is a simplified flow diagram illustrating an image search process according to embodiments of the present invention.

FIG. 4 is a simplified flow diagram illustrating a video encoding process according to embodiments of the present invention.

FIG. 5 is a simplified flow diagram illustrating a video search process according to embodiments of the present invention.

FIG. 6 is a simplified block diagram illustrating an exemplary computer system according to embodiments of the present invention.

### DETAILED DESCRIPTION OF THE INVENTION

This application directs to methods and systems for visual content retrieval using semantic search. An embodiment provides a method for generating media feature vectors from media data segments using jointly trained machine learning models, and storing these with entity indicators in a vector-based search database. An input vector is generated from text or image data, and a processor calculates cosine similarities between the input vector and existing media feature vectors to retrieve and rank relevant media segments. The method also includes generating a mean feature vector from the retrieved set and comparing it with mean feature vectors of other entities for ranking. There are other embodiments as well.

In various embodiments, embodiments of the present invention provide a method for retrieving visual content using natural language phrases (e.g., semantic search). Deep learning techniques are used to generate feature vectors of visual content and feature vectors from natural language phrases and return the closest match between the two. These feature vectors, or embeddings, carry semantic meanings of visual or textual content. It is to be appreciated that embodiments of the present invention can be e applied in a variety of applications and domains. For example, in social media, embodiments of the present invention can used to find image or video posts that semantically match with natural language phrases.

It is to be appreciated the embodiments of the present invention provide a novel and unique approach to searching relevant images or videos using natural language processing and computer vision techniques. It allows searching by inputting natural language phrases and by inputting images of interest. Deep learning models are used to perform searches on images and videos in a novel way respectively.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Furthermore, the methods and processes described herein may be described in a particular order for case of description. However, it should be understood that, unless the context dictates otherwise, intervening processes may take place before and/or after any portion of the described process, and further various procedures may be reordered, added, and/or omitted in accordance with various embodiments.

Unless otherwise indicated, all numbers used herein to express quantities, dimensions, and so forth should be understood as being modified in all instances by the term “about.” In this application, the use of the singular includes the plural unless specifically stated otherwise, and use of the terms “and” and “or” means “and/or” unless otherwise indicated. Moreover, the use of the terms “including” and “having,” as well as other forms, such as “includes,” “included,” “has,” “have,” and “had,” should be considered non-exclusive. Also, terms such as “element” or “component” encompass both elements and components comprising one unit and elements and components that comprise more than one unit, unless specifically stated otherwise.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items. By way of example, the phrases “at least one of A, B, and C” or “at least one of A, B, or C” each refer to only A, only B, or only C; and/or any combination of A, B, and C. In instances where it is intended that a selection be of “at least one of each of A, B, and C,” or alternatively, “at least one of A, at least one of B, and at least one of C,” it is expressly described as such.

For semantic language searches, there various numerous deep learning models. For example, contrastive language-image pre-training (CLIP) model can understand relationships between text and images. A CLIP model may leverage 512-dimensional vectors from images or texts. These feature vectors carry semantic meaning, and the correlation between image feature vectors and text feature vectors can tell us how close they are in an n-dimensional vector space.

For example, a feature vector for an image is defined in Equation 1:

$$\vec{I} = \{ {i}_{1} , {i}_{2} , {i}_{3} , {i}_{4} , … , {i}_{n} \} ∈ {R}^{n} \qquad Equation 1$$

A feature vector for a natural language text is defined in Equation 2:

$$\vec{T} = \{ {t}_{1} , {t}_{2} , {t}_{3} , {t}_{4} , … , {t}_{n} \} ∈ {R}^{n} \qquad Equation 2$$

where n is the number of features from a particular deep learning model. Depending on the implementation, deep learning models, which can generate features ranging from tens to thousands.

The next step is for image features and text features to correlate. To achieve that, a deep learning model can be trained with a large dataset, where images and texts are grouped together. An important mechanism for correlating image features and text features, as employed in various implementations, is to perform similarity calculation. As an example, similarity between image features and text features may calculated using cosine similarity, which is defined in Equation 3:

$$Similarity ( \vec{I} , \vec{T} ) = cosine ( \vec{I} , \vec{T} ) = \frac{\vec{I} \cdot \vec{T}}{\vert \vec{I} \vert \vert \vec{T} \vert} \qquad Equation 3$$

For example, a scheme using feature vectors and the above equations allows the retrieval of a list of images using natural language phrases, sorted by the closest relevance.

Images are often grouped (for example by the same creator in social media, or the same artist in a gallery), and there is a need to find the group of images matching the natural language text. For example, the term “entity” refers to a group of images, where the entity could be interpreted as—for example—the creator of the images. We can extend the proposed technique here by computing the mean embedding of the group of images and compare against the input text's feature vector.

The input to the search can be an image instead of a natural language text. The feature vector of the input image is used to compare with feature vectors of images in the search space. Depending on the application, embodiments of the present invention provide support for image-to-image search and also image-to-video search.

In various embodiments, two processes for image content retrieval are provided: 1) image encoding process, and 2) image search process. Depending on the implementation, methods can be applied to individual image searches as well as grouped image searches, and the difference being the step of computing the mean embedding for the entities. For example, terms “feature vector”, “encoding”, and “embedding” may be used interchangeably; as an example, a text embedding may be obtained by computing the feature vector from the text (i.e., the text encoding process), and an image embedding may be generated by computing the feature vector of the image (i.e., the image encoding process).

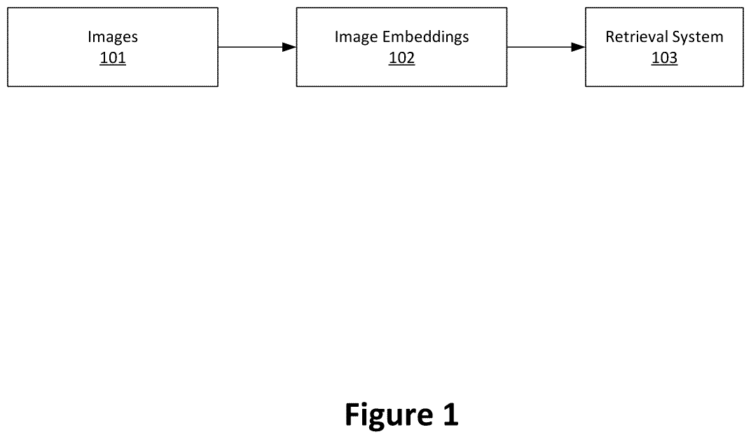

FIG. 1 is a simplified flow diagram illustrating an image encoding process according to embodiments of the present invention. This diagram is merely an example, which should not unduly limit the scope of the claims. One of ordinary skill in the art would recognize many variations, alternatives, and modifications. For example, one or more steps may be added, removed, repeated, rearranged, overlapped, modified, or replaced, and should not limit the scope of claims.

At block 101, images are received.

At block 102, images are encoded by computing their feature vectors. For example, feature vectors for image may be encoded according to Equation 1 above. In a specific embodiment, feature vector may be in CLIP format with 512 dimensions. Depending on the implementation, feature vectors may be determined in various ways. For example, feature vectors may be obtained using machine learning tools, where objects in images are identified. In various embodiments, convolutional neural networks (CNNs) may be used for image feature extraction, and specialized processors such as neural processing unit or graphic processing unit may be used to implement CNNs or other machine learning tools.

At block 103, embeddings are stored in a fast information retrieval system. For example, a retrieval system may implement a vector database, with storage optimized machine with fast solid state drive (SSD).

In various embodiments, vector databases are used for storing and efficiently searching high-dimensional vectors (or embeddings), which allows for finding data points that are semantically or contextually similar to a query vector. Among others, vector databases may be implemented in accordance with FAISS, Milvus, Pinecone, Weaviate, or others.

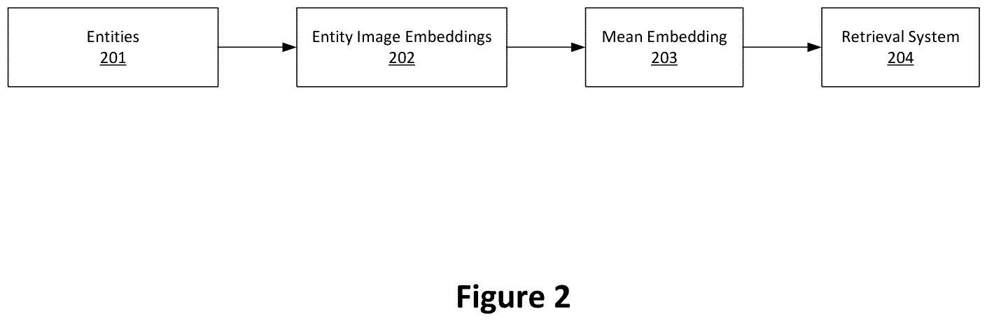

FIG. 2 is a simplified flow diagram illustrating an image encoding process with entity embeddings according to embodiments of the present invention. This diagram is merely an example, which should not unduly limit the scope of the claims. One of ordinary skill in the art would recognize many variations, alternatives, and modifications. For example, one or more steps may be added, removed, repeated, rearranged, overlapped, modified, or replaced, and should not limit the scope of claims.

At block 201, entities are identified. For example, entities may include creators, artists, and others.

At block 202, entity image embeddings are provided. For example, images created by the artist, and images are grouped together to allow for finding the right artist by using his/her images.

At block 203, for each entity, mean embeddings are generated from image embeddings related to that entity. For example, mean embedding involves averaging feature vectors of images, which creates a single vector that represents the overall “meaning” of the image.

At block 204, entity mean embeddings are also stored in the information retrieval system. For example, information retrieval system may implement a vector database.

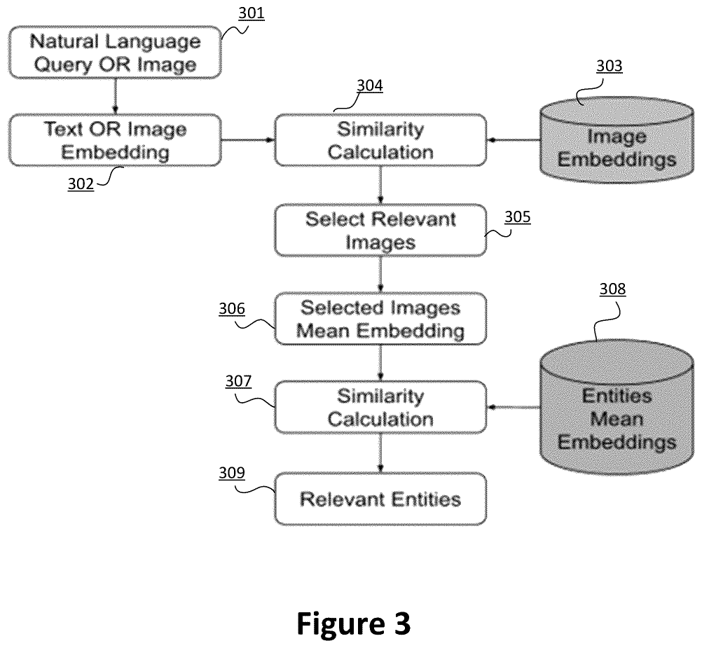

FIG. 3 is a simplified flow diagram illustrating an image search process according to embodiments of the present invention. This diagram is merely an example, which should not unduly limit the scope of the claims. One of ordinary skill in the art would recognize many variations, alternatives, and modifications. For example, one or more steps may be added, removed, repeated, rearranged, overlapped, modified, or replaced, and should not limit the scope of claims.

At block 301, a search input is received. For example, search input may include a string of natural language text, an image, or a combination of text and image. In various embodiments, a machine learning model calculates an embedding based on the search input. For example, a 512-dimension vector may be generated for a text input, regardless of its length. Similarly, a 512-dimension vector may be generated for an image input, regardless of its dimensions.

At block 302, the input natural language's text embedding is generated. If an input image is used, then its image embedding is generated. In various embodiments, a machine learning model calculates an embedding based on the search input. For example, a 512-dimension vector may be generated for a text input, regardless of its length. Similarly, a 512-dimension vector may be generated for an image input, regardless of its dimensions. For example, embedding generated at block 302 is in the same format (e.g., 512-dimension feature vector) as the image embeddings obtained at block 303.

In various embodiments, SentenceTransformers may be used for creating sentence embeddings and facilitating connections between textual data and image data. For example, a SentenceTransformers based machine learning model is used for creating high-quality vector representations (embeddings) for sentences and text passages. These embeddings capture the semantic meaning of the text. For example, SentenceTransformers may be to generate image embeddings that capture the visual content of an image. Sentence Transformers may be used to generate a text embedding for the query,

At block 303, image embeddings are obtained from a retrieval system (e.g., block 204 in FIG. 2).

At block 304, similarity calculation is performed between the input text/image embedding (from block 302) and image embeddings (from block 303) stored in the information retrieval system via non-metric space searching algorithm (e.g., NMSLIB), which allows for fast similarity calculation. As mentioned above, cosine similarity or other similarity calculations may be used. For example, cosine similarity will return a value between 0 to 1, where 1 means the two vectors are identical. For example, cosine similarity calculation, as expressed in Equation 3, may be used.

As explained above, input embedding (from block 302) and image embedding (from block 303) are in the same vector follow to allow cosine similarity calculation. In various embodiments, vectors are normalized to make magnitudes comparable. For example, block 304 may involve applying cosine similarity equation to compute the similarity between the normalized text and image vectors. The cosine similarity will range between 0 and 1. Closer to 1 indicates higher similarity between the text and the image. Closer to 0 suggests very little similarity between the text and the image. In various embodiments, cosine similarity calculations are performed in parallel by different processors or cores, to allow for high performance. In various embodiments, similarity thresholds may be used.

At block 305, user selects relevant images from the search results generated from block 304. For example, a user interface is provided for user selection in UI. In various embodiments, similarity calculation at block 304 and image selection at block 305 may be performed by different systems (e.g., a server in a datacenter for block 304, and a personal computing device for block 305).

At block 306, mean embedding is computed from selected images' embeddings.

At block 307, similarity calculation is performed between the mean embedding of the selected images and the entity mean embeddings (from block 308) via similarity calculation (e.g., similarity calculation used in block 304). For example, the selected images are compared with the entities' images, which involves comparing “mean” of user selected images and “mean” of entities' images. For example, the comparison is performed using all entities in the database of the retrieval system to find the most similar entity, given the input “mean”.

At block 309, relevant entities are returned in a sorted order of their similarity to the mean embedding of the selected images. For example, relevant entities may be listed as a ranked list (e.g., entities being sorted based on similarity score in a descending order).

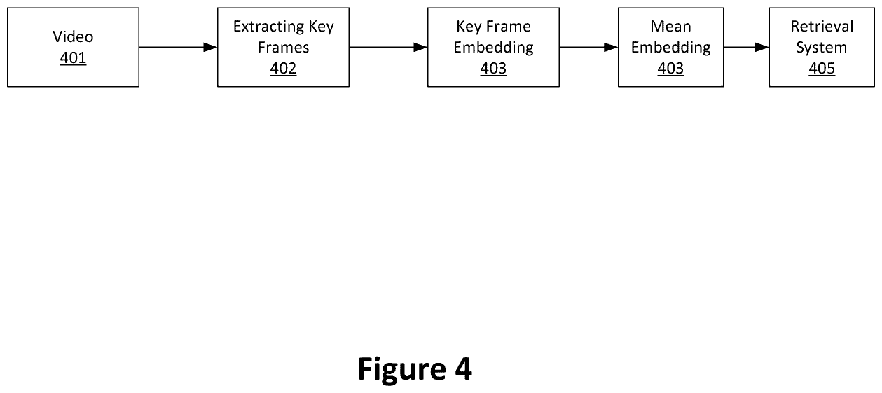

FIG. 4 is a simplified flow diagram illustrating a video encoding process according to embodiments of the present invention. This diagram is merely an example, which should not unduly limit the scope of the claims. One of ordinary skill in the art would recognize many variations, alternatives, and modifications. For example, one or more steps may be added, removed, repeated, rearranged, overlapped, modified, or replaced, and should not limit the scope of claims.

At block 401, a video is received. For example, the video may be encoded in various formats, which may affect key frame extraction process.

At block 402, key frames are extracted as a set of images. In various embodiments, key frames may be determined by scene changes. For example, a key frame is captured for each per scene. Depending on the implementation, various types of machine learning models may be used to identify scenes for key frame extraction. Time code is stored in metadata of key frames (e.g., metadata of key frame indicates that the key frame is at 1:14.13).

At block 403, key frame embeddings are determined. For example, each key frame is associated with a feature vector embedding. For example, various machine learning models may be used to determine key frame embeddings. In a specific embodiment, feature vector may be in CLIP format with 512 dimensions. Depending on the implementation, feature vectors may be determined in various ways. For example, feature vectors may be obtained using machine learning tools, where objects in images are identified. In various embodiments, convolutional neural networks may be used for image feature extraction, and specialized processors such as neural processing unit or graphic processing unit may be used to implement CNNs or other machine learning tools.

At step 404, mean embedding is computed from key frame embeddings. For example, mean embedding involves averaging feature vectors of images, which creates a single vector that represents the overall “meaning” of the image.

At step 405, key frame embedding and mean embedding are stored in a information retrieval system. For example, a retrieval system may implement a vector database. In various embodiments, vector databases are used for storing and efficiently searching high-dimensional vectors (or embeddings), which allows for finding data points that are semantically or contextually similar to a query vector. Among others, vector databases may be implemented in accordance with FAISS, Milvus, Pinecone, Weaviate, or others.

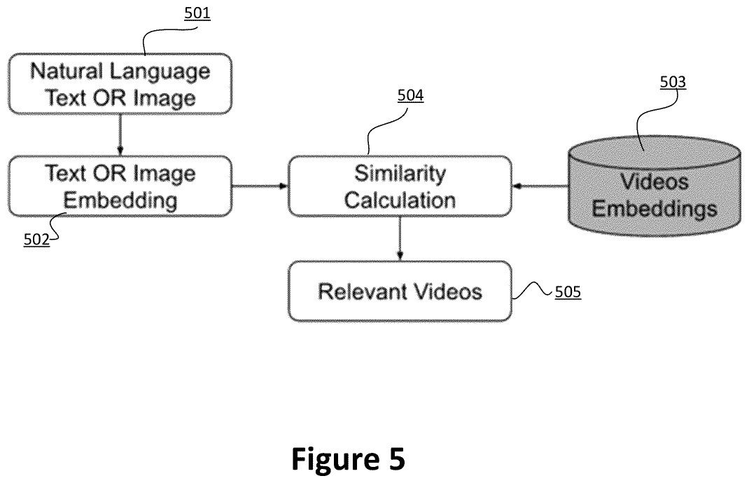

FIG. 5 is a simplified flow diagram illustrating a video search process according to embodiments of the present invention. This diagram is merely an example, which should not unduly limit the scope of the claims. One of ordinary skill in the art would recognize many variations, alternatives, and modifications. For example, one or more steps may be added, removed, repeated, rearranged, overlapped, modified, or replaced, and should not limit the scope of claims.

At block 501, For example, search input may include a string of natural language text, an image, or a combination of text and image. In various embodiments, a machine learning model calculates an embedding based on the search input. For example, a 512-dimension vector may be generated for a text input, regardless of its length. Similarly, a 512-dimension vector may be generated for an image input, regardless of its dimensions. For example, uniformity and format in vector dimensions standardizes the input data into a consistent format conducive to subsequent processing steps.

At block 502, the input natural language's text embedding is generated. If an input image is used, then its image embedding is generated. In various embodiments, a machine learning model calculates an embedding based on the search input. For example, a 512-dimension vector may be generated for a text input, regardless of its length. Similarly, a 512-dimension vector may be generated for an image input, regardless of its dimensions. For example, embedding generated at block 302 is in the same format (e.g., 512-dimension feature vector) as the image embeddings obtained at block 303.

At block 504, similarity calculation is performed between the input text/image embedding (from block 502) and video embeddings (from block 503) stored in the information retrieval system via non-metric space searching algorithm, such as non-metric space library (NMSLIB), to facilitate fast similarity calculation. As mentioned above, cosine similarity or other similarity calculations may be used. For example, cosine similarity returns a value between 0 to 1, where 1 means the two vectors are identical.

At block 505, relevant videos returned in a sorted order of similarity. In various embodiments, the process not only identifies specific scenes within a video (indicated by key frames), but also retrieves the video containing these scenes. The result may be a ranked list of relevant videos or entities, sorted in descending order of similarity. It is to be appreciated that structured output helps direct users to the most pertinent video content relative to their search input, optimizing the search and retrieval process.

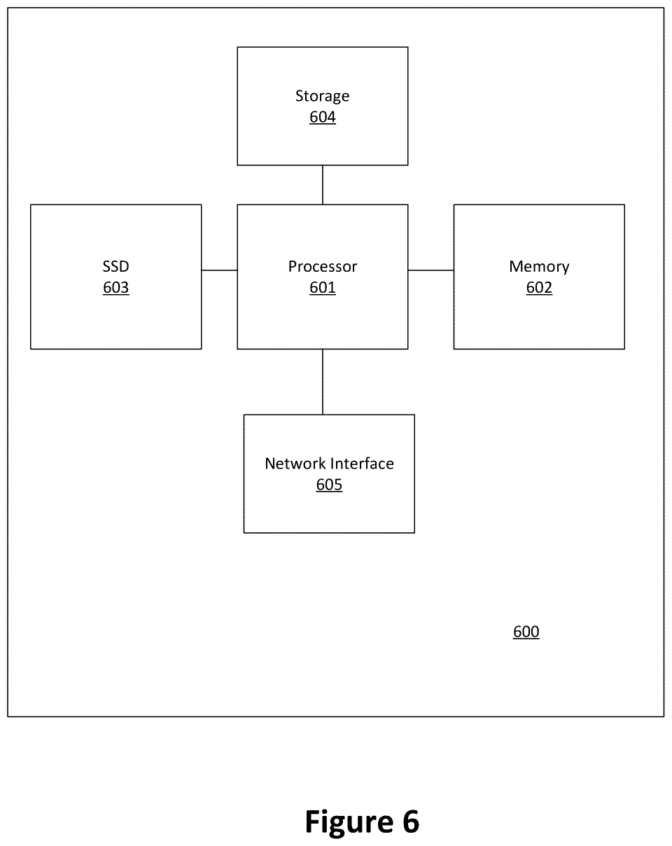

FIG. 6 is a simplified block diagram illustrating an exemplary computer system according to embodiments of the present invention. This diagram is merely an example, which should not unduly limit the scope of the claims. One of ordinary skill in the art would recognize many variations, alternatives, and modifications. System 600 includes processor 601, memory 602, solid state drive 603, storage 604, and network interface 605. There may be other components as well.

Processor 601 comprises a central processing unit (CPU), a graphics processing unit (GPU), and/or a neural processing unit (NPU). For example, CPU, GPU, and NPU each may include one or more cores. CPU, GPU, and NPU may be optimized in handling specific types of calculations and processes. For instance, tasks such as similarity calculations and image embeddings benefit significantly from the computational power and architecture of GPUs and NPUs. GPUs and NPUs are adept at managing matrix calculations, which are central to computing cosine similarities, thereby enhancing performance and operational efficiency. While a CPU is capable of performing these calculations, it does so at a slower pace, making GPUs and NPUs preferable for their speed and efficiency in process-intensive tasks.

Storage 604 may be implemented using hard disk, SSD, or other types of storage devices. For example, storage 604 may be used to store images and vector database, which typically do not require the high-speed data access provided by more volatile memory forms (e.g., random access memory 602). In contrast, memory 602, such as random access memory (RAM), provides rapid data access and is utilized for tasks demanding quick data retrieval, such as processing large volumes of cosine similarity computations. However, due to the high cost associated with large capacities of RAM-potentially extending into terabytes—it is often economically impractical for extensive data processing tasks illustrated in FIGS. 1-5.

For example, when a large number of cosine similarity computations are performed, data associated used in these computations typically need to be in main memory (e.g., memory 602). However, terabytes of memory are very expansive, so instead high speed SSD (e.g., SSD 603) may be used as a high-speed alternative to RAM. For example, servers with extremely fast SSDs can support 400 K to 4 M input/output operations per second (IOPS). These SSDs can be over 100 times faster than consumer grade SSDs (e.g., as used to implement storage 604). Using fast SSD 603 and memory 602, system 600 can efficiently manage and leverage memory mapped files to perform the computation partially in memory and partially on fast SSD. For example, retrieval systems illustrated in FIGS. 1 and 2 may be implemented with highly storage optimized machines with extremely fast SSDs.

According to an embodiment, present disclosure provides a system and method for the semantic retrieval and organization of media content, leveraging advanced machine learning technology to process and compare media feature vectors. For example, the system is designed to enhance the precision and relevance of search results across various types of media data segments, such as images or video clips, by utilizing a sophisticated set of processes.

In an embodiment, the present disclosure provides a method that involves the generation of a first set of media feature vectors. These vectors are produced by processing each media data segment through a first machine learning model. The processor, which may be equipped with a neural processing unit (or a graphic processing unit) capable of high-speed data operations, generates these vectors and subsequently computes a first mean feature vector. This mean vector represents the aggregate characteristics of the entire dataset, providing a baseline for comparison.

Once generated, both the media data segments and an indicator of their associated entity—typically the creator—are stored within a database. In various implementations, the database is specially tailored for vector search, allowing for efficient retrieval based on the generated vectors.

A search process begins when an input feature vector is created from the user-provided search input data, which can be either text or an image. This input is processed through a second machine learning model that has been jointly trained with the first model to ensure consistent and accurate feature extraction. For example, the system calculates a set of cosine similarities to determine the semantic proximity between the input feature vector and a second set of media feature vectors retrieved from the database.

Following the similarity assessment, the processor obtains a second set of media data segments from the database, which includes those segments initially stored and additional relevant segments based on the similarity scores. A second mean feature vector is then generated from this expanded set, facilitating a more refined comparison against mean feature vectors of various other entities stored in the database.

At the end of a search process, the system provides a ranked list of entities based on these comparisons. The list reflects the degree of similarity between the second mean feature vector and those of other entities, assisting users in quickly locating the most relevant media segments. This ranked list may be displayed alongside the second set of media data segments associated with the retrieved feature vectors.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method, comprising:
generating, by a processor, a first set of media feature vectors based on a first set of media data segments;
generating, by the processor, a first mean feature vector based on the first set of media feature vectors;
storing, at a storage, the first set of media data segments and an indication of an entity in a database;
generating an input feature vector based on search input data;
determining, by the processor, a first set of similarities between the input feature vector and a second set of media feature vectors;
obtaining a second set of media data segments from the database based on the first set of similarities, the second set of media data segments being associated with the second set of media feature vectors and including the first set of media data segments;
generating, by the processor, a second mean feature vector based on the second set of media feature vectors;
obtaining, from the database, an indication of the plurality of entities based on a second set of similarities between the second mean feature vector and a plurality of mean feature 17 vectors, the plurality of mean feature vectors comprising the first mean feature vector and being associated with the plurality of entities; and
providing a ranked list for the plurality of entities based at least on the second set of similarities.

2. The method of claim 1, wherein:
the generating the first set of media feature vectors includes providing each media data segment from the first set of media data segments as input to a first machine learning model to provide the first set of media feature vectors;
the generating the input feature vector includes providing the search input data as input to a second machine learning model to provide the input feature vector; and
the first machine learning model and the second machine learning model are jointly trained.

3. The method of claim 1, wherein:
the entity comprises a creator of the first set of media data segments; and
the plurality of entities includes a plurality of creators of the second set of media data segments, the plurality of creators comprising the creator.

4. The method of claim 1, wherein:
the first set of media data segments comprises a first set of images; and
the second set of media data segments comprises a second set of images.

5. The method of claim 1, wherein the search input data comprises text data or image data.

6. The method of claim 1, wherein:
the first set of media data segments and the indication are organized based at least on the first set of media feature vectors and the first mean feature vector; and
the second set of media feature vectors comprises the first set of media feature vectors, the second set of media feature vectors being associated with a plurality of entities that includes the entity.

7. The method of claim 1, wherein the database comprises a vector database configured for vector search.

8. The method of claim 1, further comprising:
calculating, via the processor, a first set of cosine similarities between the input feature vector and the second set of media feature vectors to produce the first set of similarities; and
calculating, via the processor, a second set of cosine similarities between the second mean feature vector and the plurality of mean feature vectors to produce the second set of similarities; and
displaying the ranked list of the plurality of entities and the second set of media data segments associated with the second set of media feature vectors.

9. The method of claim 1, further comprising receiving an indication of a selection of the second set of media data segments, the generating the second mean feature being based on the selection of the second set of media data segments.

10. The method of claim 1, wherein the first set of media data segments comprising a set of video clips, the method further comprising selecting, via the processor, a set of key frames from the set of video clips, the generating the first set of media feature vectors being based on the set of key frames.

11. The method of claim 1, wherein the processor comprises a neural processor unit for performing similarity calculations, intermediate data associated with similarity calculations being stored in a solid state drive characterized by data rate of at least 300,000 input/output operations per second.

12. A system comprising:
a network interface;
a memory;
a storage; and
a processor, where the processor is configured to:
generate first set of media feature vectors based on a first set of media data segments;
generate a first mean feature vector based on the first set of media feature vectors;
store the first set of media data segments in a database;
generate an input feature vector based on search input data;
determine a first set of similarities between the input feature vector and a second set of media feature vectors;
generate a second mean feature vector based on a second set of media feature vectors;
obtain an indication of the plurality of entities based on a second set of similarities between the second mean feature vector and a plurality of mean feature vectors, the plurality of mean feature vectors comprising the first mean feature vector and being associated with the plurality of entities; and
provide a ranked list for the plurality of entities based at least on the second set of similarities.

13. The system of claim 12, wherein the storage is configured to store the database.

14. The system of claim 12, wherein the database stored at a remote server via the network interface.

15. The system of claim 12, wherein the processor comprises a neural processing unit or a graphic processing unit.

16. The system of claim 11, further comprising a fast solid state drive, a first intermediate data associated with similarity calculations being stored in the memory, a second intermediate data associated with the similarity calculations being stored in the fast solid state drive.

17. The system of claim 11, wherein:
the first set of media data segments is used as input to a first machine learning model to provide the first set of media feature vectors; and
the search input data is used as input to a second machine learning model provide the input feature vector; and
the first machine learning model and the second machine learning model are jointly trained.

18. A method, comprising:
providing a first set of media feature vectors based on a first set of media data segments;
providing a first mean feature vector based on the first set of media feature vectors using a first machine learning model;
generating an input feature vector based on search input data using a second machine learning model;
determining a first set of similarities between the input feature vector and a second set of media feature vectors;
obtaining a second set of media data segments based on the first set of similarities, the second set of media data segments being associated with the second set of media feature vectors and including the first set of media data segments;
generating a second mean feature vector based on the second set of media feature vectors;
providing an indication of the plurality of entities based on a second set of similarities between the second mean feature vector and a plurality of mean feature vectors, the plurality of mean feature vectors comprising the first mean feature vector and being associated with the plurality of entities; and
providing a ranked list for the plurality of entities based at least on the second set of similarities.

19. The device of claim 18, wherein the first machine learning model and the second machine learning model are jointly trained.
